(19) United States
(12) Patent Application Publication
(10) Pub. No.: US 2002/0143768 A1
(43) Pub. Date: Oct. 3, 2002

(54) Probe array data storage and retrieval

(76) Inventor: Anthony Berno Berno, San Jose, CA (US)

Correspondence Address: AFFYMETRIX, INC, ATTN: CHIEF IP COUNSEL, LEGAL DEPT., 3380 CENTRAL EXPRESSWAY, SANTA CLARA, CA, 95051, US

(21) Appl. No.: 09/745,826

(22) Filed: Dec. 21, 2000

(51) Int. Cl. G06F 7/00

(52) U.S. Cl. 707/10

(57) ABSTRACT

Methods, systems and computer software products are provided for efficient management of large data sets. In one preferred embodiment, data are grouped according to their most frequent access requirement. Each group of the data is encoded as a single binary object. The binary objects are stored in a relational database. Component software product for encoding and decoding are also provided.

### FIELD OF INVENTION

This invention is related to bioinformatics and biological data analysis. Specifically, this invention provides methods, computer software products and systems for data storage and retrieval.

### BACKGROUND OF THE INVENTION

Biological assays using high density nucleic acid or protein probe arrays generate a large amount of data. Methods for storing, querying and analyzing such data have been disclosed in, for example, U.S. patent application Ser. Nos. 09/122,127, 09/122,169, and 09/122,304, all incorporated herein by reference in their entireties for all purposes.

### SUMMARY OF THE INVENTION

The current invention provides methods, systems and computer software products suitable for storing and retrieving nucleic acid probe array data (such as intensity and design information) efficiently. The methods, software and systems of the invention is not only useful for managing nucleic acid probe array data, they are also useful for managing other types of large data sets, such as protein array data, that are not frequently accessed in arbitrary ways.

In one aspect of the invention, methods are provided for data management. The methods include grouping a set of data according to its most common access requirements into a plurality of groups; and storing the groups in a database as single binary objects, wherein each of the groups is stored as one single binary object. The database is preferably a relational database. The set of data need not to be frequently accessed in arbitrary ways. The encoding of a group of data into a binary object may be performed by component software, such as a Microsoft® COM object. Methods for retrieving the data are also provided. In some embodiments, the methods include retrieving the binary objects from the relation database; decoding the binary objects into the set of data; wherein the binary objects are encoded in a data structure format that is compatible on a binary level with the decoding. The decoding can be performed by a component software such as a COM object.

The methods are particularly useful for managing probe intensity data. In some embodiments, the methods are used to manage data from gene expression monitoring experiments where multiple probes are used and data from each probe set may be grouped into one single binary object.

In some preferred embodiments, probes for tiling 25, or 250 bases in a target sequence are grouped into segments. Intensity values and probe design information may be grouped according to their segments and stored as binary objects.

In preferred embodiments, methods for managing a plurality of intensity values for a plurality of probes include grouping the intensity values into a plurality of groups according to the most common access requirement; and storing the groups in a database as single binary objects, wherein each of the groups is stored as one single binary object. The preferred database is a relational database. The grouping step may include encoding the data into the binary objects, preferably performed by a component software such as a COM object. The probe intensity values may be grouped according to the probe set and segment the probes interrogate. In some embodiments, methods for retrieving data include retrieving the binary objects from the relation database; decoding the binary objects into the set of data; wherein the binary objects are encoded in a data structure format that is compatible on a binary level with the decoding.

In some preferred embodiments, methods for managing probe design information are also provided. The methods include grouping the probe design information into a plurality of groups according to the most common access requirement; and storing the groups in a database as single binary objects, wherein each of the groups is stored as one single binary object. The database is preferably a relational database. The grouping may be based upon the segment of the probes.

In another aspect of the invention, systems for data management are provided. The systems include a processor; and a memory coupled with the least one processor, the memory storing a plurality of machine instructions that cause the processor to perform the method step of the invention.

Computer software products for data management are also provided. The computer software products include a computer readable medium having computer-executable instructions for performing the methods of the invention. The software may be a component software for decoding and encoding binary objects.

In yet another aspect of the invention, computer readable medium having stored thereon a data structure are also provided. The data structure include a first table comprising a first field containing a first and a second field containing or referring to a binary object, wherein the binary object contains probe intensity values; and a second table comprising a first field containing the first identifier, wherein the first table is related to a second table by the first identifier. The second table may store probe tiling design.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates an example of a computer system that may be utilized to execute the software of an embodiment of the invention.

FIG. 2 illustrates a system block diagram of the computer system of FIG. 1.

FIG. 3 shows an exemplary multi-tier networked database architecture.

FIG. 4 shows a process for storing large data set as binary objects.

FIG. 5 shows a process for retrieving data from binary objects.

FIG. 6 shows a process for storing probe intensities from gene expression monitoring experiments as binary objects.

FIG. 7 shows a process for retrieving probe intensities from gene expression monitoring experiments stored as binary objects.

FIG. 8 shows a process for storing probe intensities from sequence variation detection experiments as binary objects.

FIG. 9 shows a process for retrieving probe intensities stored as binary objects.

FIG. 10 shows a process for storing probe design information as binary objects.

FIG. 11 shows a process for accessing probe design information stored as binary objects.

FIG. 12 shows an Entity Relational Diagram for a database suitable for storing probe design and intensity data.

### DETAILED DESCRIPTION OF THE PREFERRED EMBODIMENTS

Reference will now be made in detail to the preferred embodiments of the invention. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention. All cited references, including patent and non-patent literature, are incorporated herein by reference in their entireties for all purposes.

I. DATABASE MANAGEMENT SYSTEMS (DBMS)

In one aspect of the invention, methods, computer software, data structures and systems are provided for efficient data storage and retrieval. The embodiments of the invention employs DBMS for data storage and retrieval. The software products of the invention may be a part of a DBMS or interact with a DBMS. In addition, the data structure of the invention may reside in a DBMS.

A DBMS is a computerized record-keeping system that stores, maintains and provides access to information. For a general overview of the DBMS, see, e.g., Fred R. McFadden, et al, Modern Database Management, Oracle 7.3.4 edition, Hardcover (June 1999), Addison-Wesley Pub Co (Net); ISBN: 0805360549, which is incorporated herein by reference for all purposes.

A database system generally involves three major components: Data, Hardware and Software. Data itself consists of individual entities, in addition to which there will be relationships between entity types linking them together. The mapping of the collection of data onto a DBMS is usually done based on a data model. Various architectures exists for databases and various models have been proposed including the relational, network, and hierarchic models.

Conventional DBMS hardware consists of storage devices, typically, secondary storage devices, usually hard disks, on which the database physically resides, together with the associated I/O devices, device controllers, I/O channels and etc. Databases run on a range of machines, from personal computers to large mainframes, including database machines, which is hardware designed specifically to support a database system. For a description of basic computer systems and computer networks, see, e.g., Introduction to Computing Systems: From Bits and Gates to C and Beyond by Yale N. Patt, Sanjay J. Patel, 1st edition (Jan. 15, 2000) McGraw Hill Text; ISBN: 0072376902; and Introduction to Client/Server Systems : A Practical Guide for Systems Professionals by Paul E. Renaud, 2nd edition (June 1996), John Wiley & Sons; ISBN: 0471133337, both are incorporated herein by reference in their entireties for all purposes.

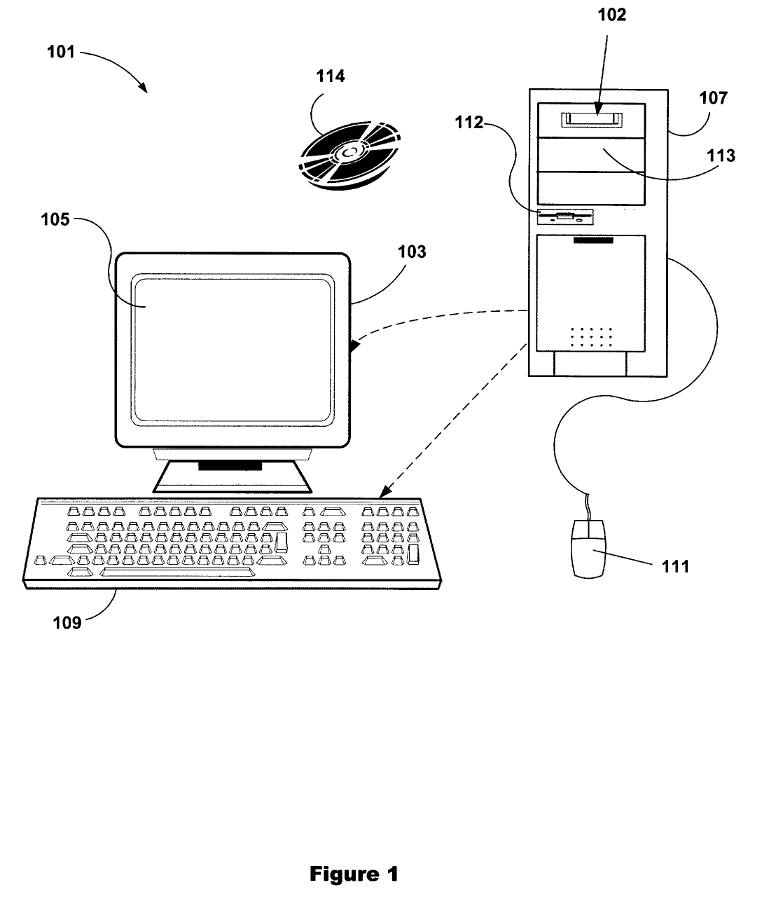

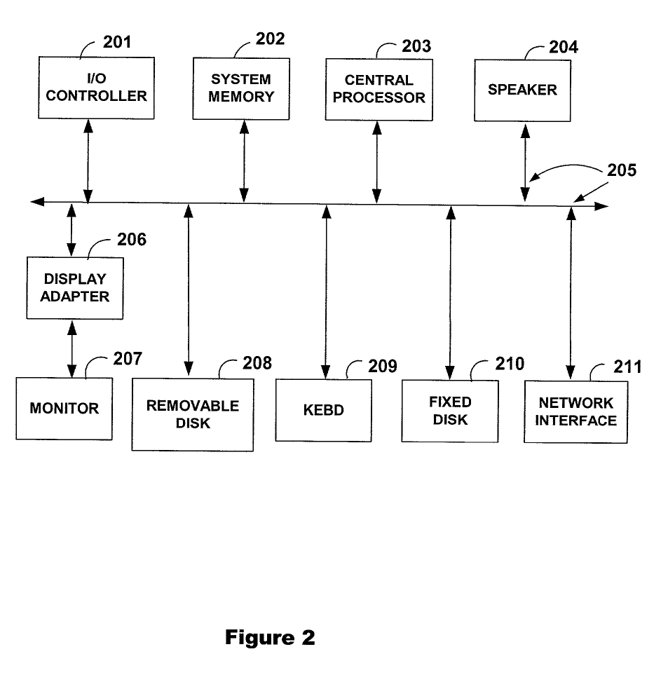

FIG. 1 illustrates an example of a computer system that may be used to execute the software of an embodiment of the invention, for storing data according to embodiments of the methods, software and systems of the invention. The computer system described herein is also suitable for hosting a DBMS. FIG. 1 shows a computer system 101 that includes a display 103, screen 105, cabinet 107, keyboard 109, and mouse 111. Mouse 111 may have one or more buttons for interacting with a graphic user interface. Cabinet 107 houses a floppy drive 112, CD-ROM or DVD-ROM drive 102, system memory and a hard drive (113) (see also FIG. 2) which may be utilized to store and retrieve software programs incorporating computer code that implements the invention, data for use with the invention and the like. Although a CD 114 is shown as an exemplary computer readable medium, other computer readable storage media including floppy disk, tape, flash memory, system memory, and hard drive may be utilized. Additionally, a data signal embodied in a carrier wave (e.g., in a network including the Internet) may be the computer readable storage medium.

FIG. 2 shows a system block diagram of computer system 101 used to execute the software of an embodiment of the invention. As in FIG. 1, computer system 101 includes monitor 201, and keyboard 209. Computer system 101 further includes subsystems such as a central processor 203 (such as a Pentium™ III processor from Intel), system memory 202, fixed storage 210 (e.g., hard drive), removable storage 208 (e.g., floppy or CD-ROM), display adapter 206, speakers 204, and network interface 211. Other computer systems suitable for use with the invention may include additional or fewer subsystems. For example, another computer system may include more than one processor 203 or a cache memory. Computer systems suitable for use with the invention may also be embedded in a measurement instrument.

When a DBMS runs on a computer, it typically runs as yet another application program. In between the DBMS and the hardware of the machine lies the host machine's operating system such as UNIX, Windows NT, Windows 2000, Linux or VAX/VMS, file manager and disk manager which deal with the file structure of the operating system and the page structure of the machine. DBMS may also run in a distributed fashion in several, even a large number of, machines connected via a network.

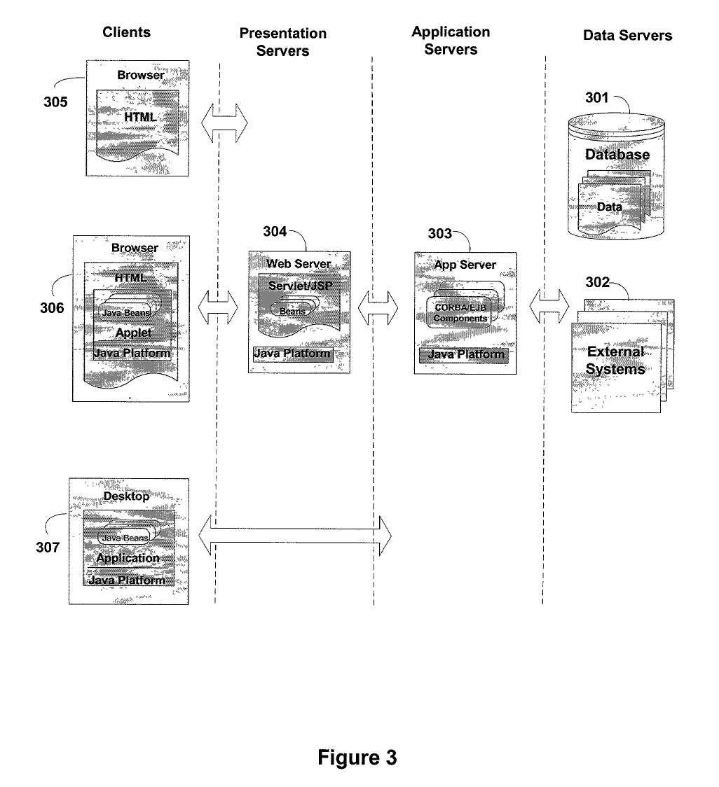

FIG. 3 shows an embodiment of a multi-tier internet database system that is useful for some embodiments of the invention (For a description of an Internet database platform, see, e.g., the Java™ 2 Platform, Enterprise Edition Application Programming Model described by Sun Microsystems, see http://java.sun.com/j2ee/apm/, last accessed on Dec. 14, 2000). The database (301), e.g. a gene expression database or a genotyping database, and system external to the data (302) reside in one or several data servers which constitute the data server tier.

Java enabled application servers (303) contain distributed, reusable business components housed in either a Java Common Object Request Broker Architecture (CORBA) Object Request Broker (ORB) or an Enterprise JavaBean (EJB) server. For a description of the distribute object technology, see, e.g., specifications and other documents at the web-site of the Object Management Group (OMG), http://www.omg.org, all incorporated herein by reference for all purposes.

The business components publish their data and services to Graphic User Interface (GUI) clients or other servers via component application programming interfaces (APIs) like CORBA and EJB, messaging APIs like Java Messenger Service (JMS), or data exchange formats like Extensible Markup Language (XML). The April 2000 specification of the XML is available at the http://www.w3.org and is incorporated herein by reference for all purposes.

The business components typically encapsulate and interact with persistent data stored within a standard relational database accessed via Java Database Connectivity (JDBC). Business components may also encapsulate data and services that are integrated from a variety of different data stores and applications.

Thin client HTML interfaces (305) are dynamically generated by Java enabled web servers (304) using, for example, JavaServer Pages (JSP) and Java Servlet standards (www.javasoft.com). More functionally rich and productive thick clients are assembled from libraries of reusable JavaBeans. The Java clients can run either as applets augmenting HTML within a Java enabled browser (306) or as applications running independently on the desktop (307). Java clients typically connect to application servers via Internet Inter-ORB Protocol (IIOP) or directly to data servers using JDBC.

II. RELATIONAL DATABASE MODEL

Different models of data lead to different organizations. In general the relational model is preferred for storing probe array data in some embodiments.

Relational databases store all of their information in groups known as tables. Each database can contain one or more of these tables. A relational database management system (RDBMS) can also manage many individual underlying databases, with each one of these databases containing many tables. These tables are related to each other using some type of common element. A table can be thought of as containing a number of rows and columns. Each individual element stored in the table is known as a column. Each set of data within the table is known as a row. There are a number of commercial or public domain relational DBMS (RDBMS) such as Oracle (www.oracle.com), Sybase (www.sybase.com), Microsoft® SQL server and MySQL (www.mysql.com).

One preferred language for managing relational database is the SQL. Structured Query Language (SQL) is an American National Standard Institute (ANSI) standard computer programming language. SQL is useful for querying and managing relational databases. The ANSI standard for SQL (SQL-92, available at www.ansi.org, last visited on Dec. 14, 2000 and incorporated herein by reference for all purposes) specifies a core syntax for the language itself. For a detailed description of the SQL language, see, e.g., The Practical SQL Handbook: Using Structured Query Language by Judith S. Bowman, et al., Addison-Wesley Pub Co; ISBN: 0201447878, which is incorporated herein by reference for all purposes. Many embodiments of the invention employ SQL for query and database management.

One important process for designing relational database is normalization. Normalization is the process of organizing data in a database. This includes creating tables and establishing relationships between those tables according to rules designed both to protect the data and to make the database more flexible by eliminating two factors: redundancy and inconsistent dependency. Redundant data waste disk space and creates maintenance problems. If data that exists in more than one place must be changed, the data must be changed in exactly the same way in all locations, which is inefficient and error prone. Inconsistent dependencies can make data difficult to access; the path to find the data may be missing or broken. There are a few rules for database normalization. Each rule is called a “normal form.” If the first rule is observed, the database is said to be in “first normal form.” If the first three rules are observed, the database is considered to be in “third normal form.” Although other levels of normalization are possible, third normal form is considered the highest level necessary for most applications. For a description of the normalization process, see, e.g, Handbook of Relational Database Design by Candace C. Fleming, et al. Addison-Wesley Pub Co; ISBN: 0201114348, which is incorporated herein by reference for all purposes.

Relational databases are an excellent way to organize data, but there can be a big per-row overhead in data storage and retrieval when there is a large number of rows in database tables. For example, in a fully normalized design, one row of data is reserved for every intensity value obtained in assays using high density probe arrays. Storing one row of data for every intensity value becomes less efficient in some systems when there are thousands of scans and billions of values.

In one aspect of the invention, methods, systems, data structures and computer software are provided to efficiently store and retrieve intensity data. The methods, systems, data structures and computer software are also useful for processing of any other large dataset.

III. HIGH DENSITY PROBE ARRAYS

The methods of the invention are particularly useful for storing probe intensity data generated using high density probe arrays, such as high density nucleic acid probe arrays. High density nucleic acid probe arrays, also referred to as “DNA Microarrays,” have become a method of choice for monitoring the expression of a large number of genes and for detecting sequence variations, mutations and polymorphism. As used herein, “Nucleic acids” may include any polymer or oligomer of nucleosides or nucleotides (polynucleotides or oligonucleotidies), which include pyrimidine and purine bases, preferably cytosine, thymine, and uracil, and adenine and guanine, respectively. See Albert L. Lehninger, PRINCIPLES OF BIOCHEMISTRY, at 793-800 (Worth Pub. 1982) and L. Stryer BIOCHEMISTRY, 4^{th} Ed., (March 1995), both incorporated by reference. “Nucleic acids” may include any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

“A target molecule” refers to a biological molecule of interest. The biological molecule of interest can be a ligand, receptor, peptide, nucleic acid (oligonucleotide or polynucleotide of RNA or DNA), or any other of the biological molecules listed in U.S. Pat. No. 5,445,934 at col. 5, line 66 to col. 7, line 51. For example, if transcripts of genes are the interest of an experiment, the target molecules would be the transcripts. Other examples include protein fragments, small molecules, etc. “Target nucleic acid” refers to a nucleic acid (often derived from a biological sample) of interest. Frequently, a target molecule is detected using one or more probes. As used herein, a “probe” is a molecule for detecting a target molecule. It can be any of the molecules in the same classes as the target referred to above. A probe may refer to a nucleic acid, such as an oligonucleotide, capable of binding to a target nucleic acid of complementary sequence through one or more types of chemical bonds, usually through complementary base pairing, usually through hydrogen bond formation. As used herein, a probe may include natural (i.e. A, G, U, C, or T) or modified bases (7-deazaguanosine, inosine, etc.). In addition, the bases in probes may be joined by a linkage other than a phosphodiester bond, so long as the bond does not interfere with hybridization. Thus, probes may be peptide nucleic acids in which the constituent bases are joined by peptide bonds rather than phosphodiester linkages. Other examples of probes include antibodies used to detect peptides or other molecules, any ligands for detecting its binding partners. When referring to targets or probes as nucleic acids, it should be understood that these are illustrative embodiments that are not to limit the invention in any way.

In preferred embodiments, probes may be immobilized on substrates to create an array. An “array” may comprise a solid support with peptide or nucleic acid or other molecular probes attached to the support. Arrays typically comprise a plurality of different nucleic acids or peptide probes that are coupled to a surface of a substrate in different, known locations. These arrays, also described as “microarrays” or colloquially “chips” have been generally described in the art, for example, in Fodor et al., Science, 251:767-777 (1991), which is incorporated by reference for all purposes. Methods of forming high density arrays of oligonucleotides, peptides and other polymer sequences with a minimal number of synthetic steps are disclosed in, for example, U.S. Pat. Nos. 5,143,854, 5,252,743, 5,384,261, 5,405,783, 5,424,186, 5,429,807, 5,445,943, 5,510,270, 5,677,195, 5,571,639, 6,040,138, all incorporated herein by reference for all purposes. The oligonucleotide analogue array can be synthesized on a solid substrate by a variety of methods, including, but not limited to, light-directed chemical coupling, and mechanically directed coupling. See Pirrung et al., U.S. Pat. No. 5,143,854 (see also PCT Application No. WO 90/15070) and Fodor et al., PCT Publication Nos. WO 20 92/10092 and WO 93/09668, U.S. Pat. Nos. 5,677,195, 5,800,992 and 6,156,501 which disclose methods of forming vast arrays of peptides, oligonucleotides and other molecules using, for example, light-directed synthesis techniques. See also, Fodor et al., Science, 251, 767-77 (1991). These procedures for synthesis of polymer arrays are now referred to as VLSIPS™ procedures. Using the VLSIPS™ approach, one heterogeneous array of polymers is converted, through simultaneous coupling at a number of reaction sites, into a different heterogeneous array. See, U.S. Pat. Nos. 5,384,261 and 5,677,195.

Methods for making and using molecular probe arrays, particularly nucleic acid probe arrays are also disclosed in, for example, U.S. Pat. Nos. 5,143,854, 5,242,974, 5,252,743, 5,324,633, 5,384,261, 5,405,783, 5,409,810, 5,412,087, 5,424,186, 5,429,807, 5,445,934, 5,451,683, 5,482,867, 5,489,678, 5,491,074, 5,510,270, 5,527,681, 5,527,681, 5,541,061, 5,550,215, 5,554,501, 5,556,752, 5,556,961, 5,571,639, 5,583,211, 5,593,839, 5,599,695, 5,607,832, 5,624,711, 5,677,195, 5,744,101, 5,744,305, 5,753,788, 5,770,456, 5,770,722, 5,831,070, 5,856,101, 5,885,837, 5,889,165, 5,919,523, 5,922,591, 5,925,517, 5,658,734, 6,022,963, 6,150,147, 6,147,205, 6,153,743, 6,140,044 and D430024, all of which are incorporated by reference in their entireties for all purposes.

Typically, a nucleic acid sample is labeled with a signal moiety, such as a fluorescent label. The sample is hybridized with the array under appropriate conditions. The arrays are washed or otherwise processed to remove non-hybridized sample nucleic acids. The hybridization is then evaluated by detecting the distribution of the label on the chip. The distribution of label may be detected by scanning the arrays to determine fluorescence intensity distribution. Typically, the hybridization of each probe is reflected by several pixel intensities. The raw intensity data may be stored in a gray scale pixel intensity file. The GATC™ Consortium has specified several file formats for storing array intensity data. The final software specification is available at www.gatcconsortium.org and is incorporated herein by reference in its entirety. The pixel intensity files are usually large. For example, a GATC™ compatible image file may be approximately 50 Mb if there are about 5000 pixels on each of the horizontal and vertical axes and if a two byte integer is used for every pixel intensity. The pixels may be grouped into cells (see, GATC™ software specification). The probes in a cell are designed to have the same sequence (i.e., each cell is a probe area). A CEL file contains the statistics of a cell, e.g., the 75th percentile and standard deviation of intensities of pixels in a cell. The 50, 60, 70, 75 or 80th percentile of pixel intensity of a cell is often used as the intensity of the cell.

Methods for signal detection and processing of intensity data are additionally disclosed in, for example, U.S. Pat. Nos. 5,547,839, 5,578,832, 5,631,734, 5,800,992, 5,856,092, 5,936,324, 5,981,956, 6,025,601, 6,090,555, 6,141,096, 6,141,096, and 5,902,723. Methods for array based assays, computer software for data analysis and applications are additionally disclosed in, e.g., U.S. Pat. Nos. 5,527,670, 5,527,676, 5,545,531, 5,622,829, 5,631,128, 5,639,423, 5,646,039, 5,650,268, 5,654,155, 5,674,742, 5,710,000, 5,733,729, 5,795,716, 5,814,450, 5,821,328, 5,824,477, 5,834,252, 5,834,758, 5,837,832, 5,843,655, 5,856,086, 5,856,104, 5,856,174, 5,858,659, 5,861,242, 5,869,244, 5,871,928, 5,874,219, 5,902,723, 5,925,525, 5,928,905, 5,935,793, 5,945,334, 5,959,098, 5,968,730, 5,968,740, 5,974,164, 5,981,174, 5,981,185, 5,985,651, 6,013,440, 6,013,449, 6,020,135, 6,027,880, 6,027,894, 6,033,850, 6,033,860, 6,037,124, 6,040,138, 6,040,193, 6,043,080, 6,045,996, 6,050,719, 6,066,454, 6,083,697, 6,114,116, 6,114,122, 6,121,048, 6,124,102, 6,130,046, 6,132,580, 6,132,996 and 6,136,269, all of which are incorporated by reference in their entireties for all purposes.

Nucleic acid probe array technology, use of such arrays, analysis array based experiments, associated computer software, composition for making the array and practical applications of the nucleic acid arrays are also disclosed, for example, in the following U.S. patent application Nos. 07/838,607, 07/883,327, 07/978,940, 08/030,138, 08/082,937, 08/143,312, 08/327,522, 08/376,963, 08/440,742, 08/533,582, 08/643,822, 08/772,376, 09/013,596, 09/016,564, 09/019,882, 09/020,743, 09/030,028, 09/045,547, 09/060,922, 09/063,311, 09/076,575, 09/079,324, 09/086,285, 09/093,947, 09/097,675, 09/102,167, 09/102,986, 09/122,167, 09/122,169, 09/122,216, 09/122,304, 09/122,434, 09/126,645, 09/127,115, 09/132,368, 09/134,758, 09/138,958, 09/146,969, 09/148,210, 09/148,813, 09/170,847, 09/172,190, 09/174,364, 09/199,655, 09/203,677, 09/256,301, 09/285,658, 09/294,293, 09/318,775, 09/326,137, 09/326,374, 09/341,302, 09/354,935, 09/358,664, 09/373,984, 09/377,907, 09/383,986, 09/394,230, 09/396,196, 09/418,044, 09/418,946, 09/420,805, 09/428,350, 09/431,964, 09/445,734, 09/464,350, 09/475,209, 09/502,048, 09/510,643, 09/513,300, 09/516,388, 09/528,414, 09/535,142, 09/544,627, 09/620,780, 09/640,962, 09/641,081, 09/670,510, 09/685,011, and 09/693,204 and in the following Patent Cooperative Treaty (PCT) applications/publications: PCT/NL90/00081, PCT/GB91/00066, PCT/US91/08693, PCT/JS91/09226, PCT/US91/09217, WO/93/10161, PCT/US92/10183, PCT/GB93/00147, PCT/US93/01152, WO/93/22680, PCT/US93/04145, PCT/US93/08015, PCT/US94/07106, PCT/US94/12305, PCT/GB95/00542, PCT/US95/07377, PCT/US95/02024, PCT/US96/05480, PCT/US96/11147, PCT/US96/14839, PCT/US96/15606, PCT/US97/01603, PCT/US97/02102, PCT/GB97/005566, PCT/US97/06535, PCT/GB97/01148, PCT/GB97/01258, PCT/US97/08319, PCT/US97/08446, PCT/US97/10365, PCT/US97/17002, PCT/US97/16738, PCT/US97/19665, PCT/US97/20313, PCT/US97/21209, PCT/US97/21782, PCT/US97/23360, PCT/US98/06414, PCT/US98/01206, PCT/GB98/00975, PCT/US98/04280, PCT/US98/04571, PCT/US98/05438, PCT/US98/05451, PCT/US98/12442, PCT/US98/12779, PCT/US98/12930, PCT/US98/13949, PCT/US98/15151, PCT/US98/15469, PCT/US98/15458, PCT/US98/15456, PCT/US98/16971, PCT/US98/16686, PCT/US99/19069, PCT/US98/18873, PCT/US98/18541, PCT/US98/19325, PCT/US98/22966, PCT/US98/26925, PCT/US98/27405 and PCT/IB99/00048, all the above cited patent applications and other references cited throughout this specification are incorporated herein by reference in their entireties for all purposes.

IV. BINARY OBJECTS FOR STORING PROBE ARRAY DATA

As discussed above, relational database can have a large per row overhead. In one aspect of the invention, methods are provided for storing and retrieving nucleic acid array intensity data much more efficiently. The methods are not only useful for managing nucleic acid probe array data, they are also useful for managing other types of data sets, for example, protein array data or any other large data set, such as protein array data, that are not frequently accessed in arbitrary way.

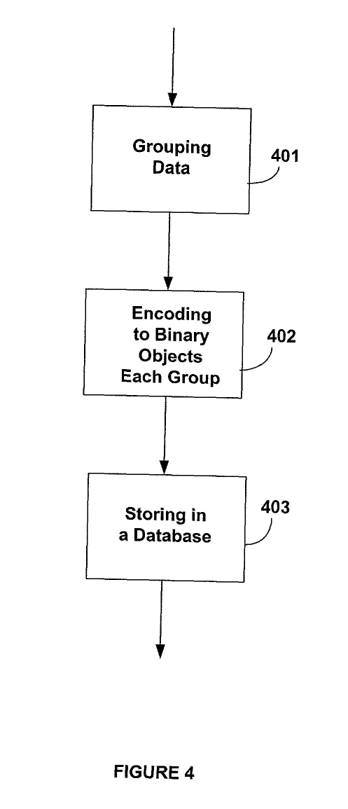

FIG. 4 shows an exemplary computerized process for managing large data set. The data are grouped according to its most common access requirement (401). For example, in one preferred embodiment, probe array intensities may be grouped into probe sets, because, most likely the intensity values in a probe set are accessed at the same time.

In some preferred embodiments, the data may be stored is stored redundantly, i.e. the same data points in several different structures according to different, often conflicting access requirements. In such embodiments, the data may be grouped in two or more ways. The redundant storage might accommodate several access “requirements”, such as “all the probes for a particular sequence” or “all probes for a particular scan.”

The data are then encoded into binary objects (402). A binary object, as used herein, refers to any large single block of data stored in a database and data cannot be directly searched by the database's search engine. One of skill in the art would appreciate that the embodiments of the invention are not limited to any particular data structure within the binary objects. For example, the binary objects maybe a serialized Java Object that contains intensity values for a probe set. For a discussion of object serialization, see, e.g., Thinking in Java by Bruce Eckel, Prentice Hall Computer Books; ISBN: 0136597238, incorporated herein by reference in its entirety for all purposes.

One group of the data is preferably encoded as a single binary object. The encoding is performed so that the data format in the binary object is compatible with the data structure used by decoding software or application software components that access the objects directly. In preferred embodiments, the encoding may be performed by a component software such as a Microsoft® Component Object Model (COM) or Distributed Component Object Model (DCOM) object that may be called by computer programs written in many languages including Visual Basic. Other component software, such as Java Beans (Sun Microsystems), and/or EJBs may also be used.

One advantage of storing data as binary object is that the binary objects tend to occupy less space. The binary objects may also be compressed to save additional space using compression algorithms familiar to one of skill in the art. For a general discussion of data compression algorithms, see, e.g., Introduction to Data Compression, Second Edition by Khalid Sayood, Morgan Kaufmann Publishers; ISBN: 1558605584, which is incorporated herein by reference in its entirety for all purposes. Data encryption may also be used to provide additional data security. For a discussion of data encryption and security, see, e.g., Cryptography & Network Security: Principles & Practice by William Stallings, Prentice Hall; ISBN: 0138690170, which is incorporated herein by reference in its entirety for all purposes.

Continuing with the process in FIG. 4, the binary object is then stored in a database, preferably a relational database. One of skill in the art would appreciate that many commercially available or public domain RDBMSs, such as Oracle, Sybase, MySQL, Microsoft™ SQL server, are suitable for storing the binary objects. The binary objects may be stored as Binary Large Objects (BLOBs) or Large Objects (LOBs) (See., e.g., Application Developer's Guide—Large Objects, Release 2 (8.1.6), Oracle Corporation, incorporated herein by reference in its entirety for all purposes). LOB (large object) is a data type for storing large amounts of data (maximum size is 4 Gigabytes) such as ASCII text, text in National Characters, files in various graphics formats, and sound wave forms.

BLOBs are traditionally used to store unstructured, or raw, data. Unstructured data is data that cannot be decomposed into a relational schema. Examples of unstructured data are pictures in any format (like GIF, JPEG, etc.), written documents (like Microsoft Word, WordPerfect, etc.) or multimedia content such as audio and video files. BLOBs can be internal or external. Internal BLOBs are stored within the database, either in-line in the table or in a separate tablespace. External BLOBs only store a reference to the operating system file within the database. The reference is done using a DIRECTORY database object and a file name. In preferred embodiments, the binary objects are stored as internal BLOBs.

In some other preferred embodiments, the binary objects may be stored as LONG or LONG RAW data type. For a comparison between LOBs and LONG or LONG RAW data types, see, e.g., Pro*C/C++ Precompiler Programmer's Guide, Release 8.1.5, Oracle Corporation, which is incorporated herein by reference for all purposes.

Storing a binary object in a relational database may be performed by executing SQL statements. Relational database data storage, query and data retrieval are well known to those skilled in the art. In addition to executing SQL statement in a RDBMS, many database connectivity products are available to facilitate the access of database. For example, Java Database Connectivity (JDBC) can be used for application programs written in Java to access relational database including storing and retrieving data from the database.

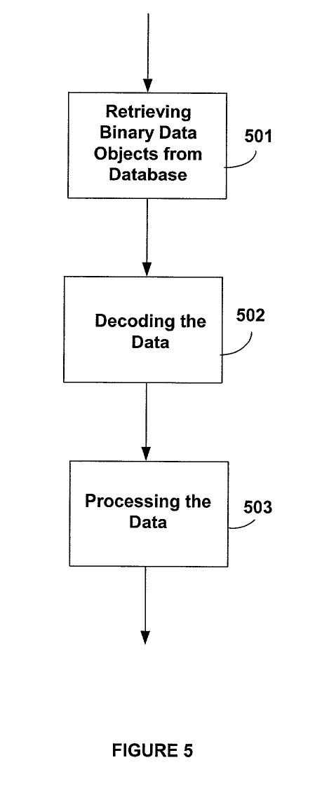

FIG. 5 shows a computerized process for retrieving data, such as probe intensities. The binary objects are retrieved from the database (501). SQL statements may be used to retrieve binary objects from the exemplary relational database.

The binary objects may be decoded to retrieve its internal data (502). Decoding may be performed by accessing the data field of the binary objects. The data are then available for further processing (503). Application programs, however, may access the binary objects and process the object's data structure directly. For example, intensity values may be encoded in the binary objects as 4 bytes float point numbers starting after certain header information. Application programs may access the float point numbers and process them directly. If the binary objects are serialized Java objects, the data may be processed by simply de-serializing the objects and the internal data will be restored in the memory and available for further processing.

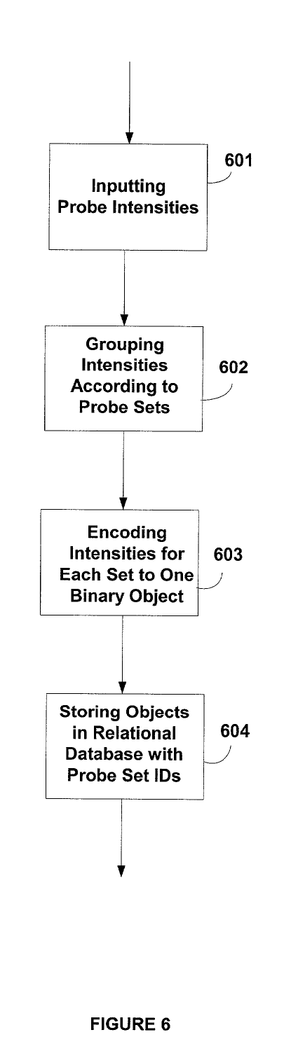

FIG. 6 shows a computerized process for storing probe intensities from gene expression experiments. In some embodiments, nucleic acid probes are used to measure the level of transcripts in biological samples. In such embodiments, frequently, the transcripts are measured with at least 3, 5, 10, 15, 20, 30, or 40 probes. For example, in one particularly preferred embodiment, a transcript is measured using 20 probes that are designed to be a perfect match with the transcript (perfect match probes) and 20 probes that are designed to contain at least one mismatch base (mismatch probes).

As an exemple, the intensity values from gene expression experiments may be inputted from various sources including data files (601). The data structure for each probe intensity value may include the intensity and identifiers that relate this probe to the transcript it detects and the position of the probe on a probe array.

The intensity data are grouped into probe sets because intensities within a group are likely to be accessed simultaneously (602). Each probe set contains probes for measuring a single transcript. The intensity values may be encoded in a binary format (603). One of skill in the art would appreciate that many formats/data structure of the binary objects are suitable for the embodiments of the invention. One exemplary structure may begin with the following header information:

struct ProbeIntensityHeader
{

| | |
|---|---|
| long version; | //indicates format of block |
| long geneID; | //relates the probes to the transcript |
| int numberProbe; | //number of probes in the probe set |
| | //tells how many elements in the array follows |

};

and then continue with an array of 4 byte floating point numbers representing probe intensity information. The array may be of 40 elements if there are 40 probes in a probe set. In this structure, the probes are identified according to their sequence in the array. Alternatively, the probes may be explicitly identified. In such embodiments, the array may contain elements of this data structure:

struct ProbeIntensity
{

| | |
|---|---|
| short x; | //x position of the probe |
| short y; | //y position of the probe |
| float intensity; | //intensity value |

};

One of skill in the art would appreciate that the embodiments of the invention are not limited to the specific data format. Other formats, such serializable Java objects, may also be used.

The objects may be stored in a RDBMS, for example, as BLOBs (604). The table for storing the BLOBS may have a field, e.g., ProbeSetID, for identifying probe sets.

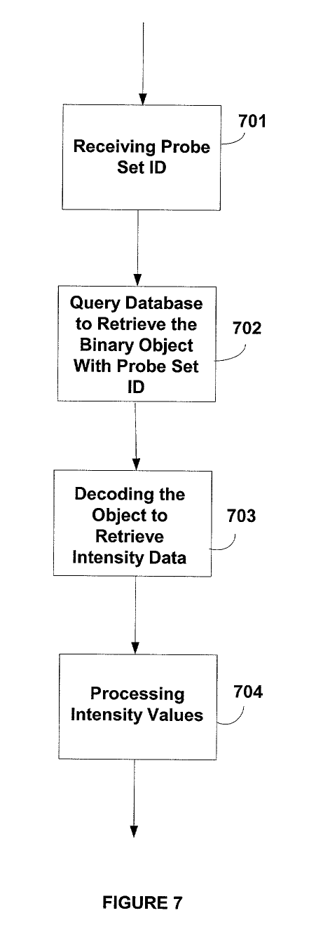

FIG. 7 shows a computerized process for processing intensity values. A probe set ID, or other probe set identifier, is received (701) from, e.g., a user or a computer program module requesting the intensity value. The binary object containing the intensity values for this probe set is retrieved from the database using the probe set ID (702). The object is decoded (704) and used (704) for further processing. As discussed above, the decoding process may be combined with processing step.

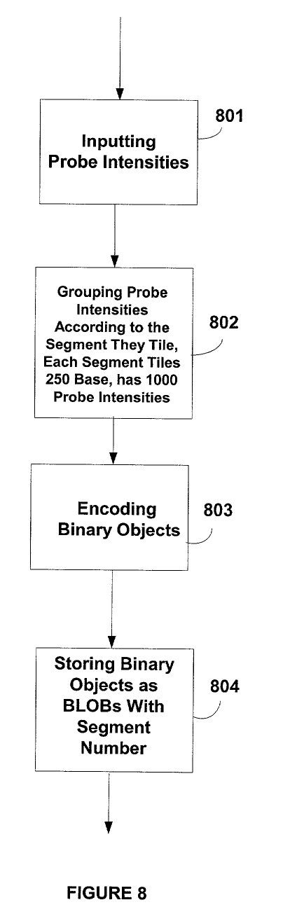

FIG. 8 shows a computerized process for storing probe intensities from experiments that use nucleic acid probe arrays to determine nucleic acid sequence variations. Sequence variation from a reference sequence may be determined using a probe tiling strategy as described in, e.g., WO 95/11995, published on May 4, 1995, incorporated herein by reference in its entirety for all purposes.

The basic tiling strategy provides an array of immobilized probes for analysis of target sequences showing a high degree of sequence identity to one or more selected reference sequences. Often, the probes contain a single interrogation position, at or near the center of probe. Often, there are four probes corresponding to each nucleotide of interest in the reference sequence. Each of the four corresponding probes has an interrogation position aligned with that nucleotide of interest. Usually, the probes from the three additional probe sets are identical to the corresponding probe from the first probe with one exception. The exception is that at least one (and often only one) interrogation position, which occurs in the same position in each of the four corresponding probes from the four probe sets, is occupied by a different nucleotide in the four probe sets. For example, for an A nucleotide in the reference sequence, the corresponding probe has its interrogation position occupied by a T, and the corresponding probes from the additional three probes have their respective interrogation positions occupied by A, C, or G, a different nucleotide in each probe. Therefore, in general, four probes are needed for each base to be interrogated.

In some preferred embodiments of the invention, the target sequence to be interrogated may be divided into segments of at least 50, 100, 200, 250, 300, and 1000 bases in length. If the segment is 250 bases in length, there will be 4×250=1000 probes and thus 1000 intensity values (also referred to as intensities throughout the specification and the accompanying drawings).

In preferred embodiments, the intensity values are grouped (802) according to which segment of a target sequence the probes interrogate (or tile). One of skill in the art would appreciate that the grouping may be dependent upon the operating environment of the DBMS and/or access requirement. For example, if 10,000 probe intensities needed to be accessed frequently at the same time, it may be desirable to group the 10,000 intensities together.

Each group of the intensities may be encoded into a single binary object (803). In one exemplary embodiment, the binary objects begin with a header with the following structure:

struct ProbeDataBlockHeader
{

| | |
|---|---|
| long version; | //indicate the format of the block |
| long length; | //number of base tiled |
| long segment; | //segment identifier |

};

and continue with 4×(length) 4 byte floating point numbers representing probe intensity information.

The binary objects are preferably stored as BLOBs in a relational database.

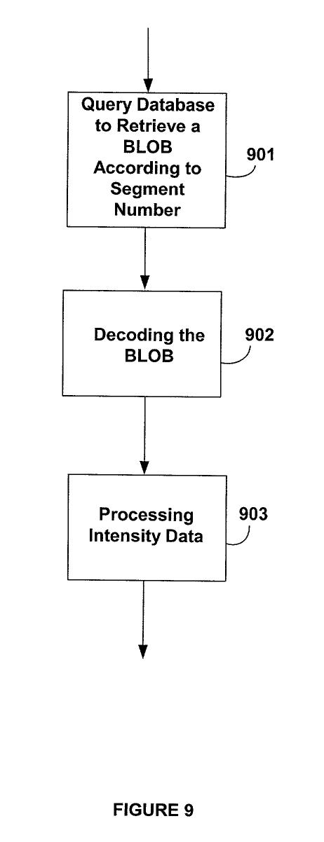

FIG. 9 shows a process for accessing the probe intensity values. The BLOBs are retrieved from the relational database using segment ID (901). The BLOBs are decoded or otherwise accessed by application programs for their internal probe intensity data.

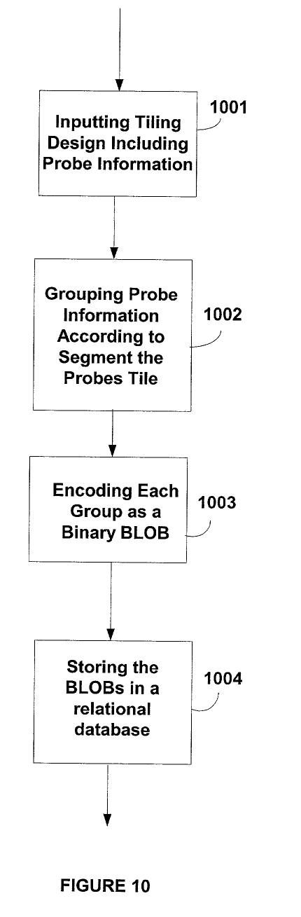

FIG. 10 shows a process for storing a large amount of probe design information, which is frequently used in conjunction with the probe intensity data.

Tiling design information is inputted to the software of the invention (1001). The information is group ed according to the segment the probes tile (1002).

Each group of the probe design information may be encoded into a single binary object. One exemplary format may start with the following heading:

struct ProbeDesignBlockHeader
{

| | |
|---|---|
| long version; | //indicate the format of the block |
| long length; | //number of base tiled |
| long segment; | //segment identifier |

};

and continue with an array of 4×(length) elements of the following data structure:

#pragma pack (push, pdstrut, 1)
struct ProbeDesign
{

| | |
|---|---|
| short x; | //x position of the probe |
| short y; | //y position of the probe |
| long offSet; | //position probe interrogates in sequence |
| char reference; | //base in reference sequence |
| char substitution; | //probe substitution base |

};
#program pack (pop, pdstruct)

The binary objects may be stored in a relational database as BLOBs (1003).

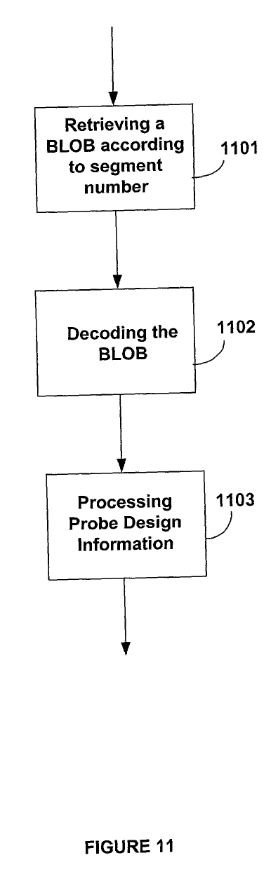

FIG. 11 shows the process for accessing probe design information. A BLOB is retrieved according to its identifier such as a segment ID (1101). The BLOB is decoded or accessed otherwise by application programs.

In another aspect of the invention, systems for managing large data set are provided. The systems include a processor, and a memory coupled with the least one processor, the memory storing a plurality of machine instructions that cause the processor to perform the methods of the invention as described above. The computer software products of the invention include a computer readable medium having machine executable instructions for performing the methods of the invention. The computer readable medium can be a floppy disk, a hard-disk drive, a CD/CD-ROM, DVD/DVD-ROM, memory sticks, any type of ROM/RAM, flash memory, optical memory devices, and optical magnetic devices and other suitable computer readable device/medium. The software products may be a fully executable stand alone application program, a component software such as a COM/DCOM, Javabean and EJB. The computer software may be written in any of the suitable programming languages such as C/C++, Java, C#, Perl, Basic, Fortran, SQL, SAS, etc.

Data structure for managing probe array data are also provided. The data structure are stored on computer readable media. The data structure include a first table comprising a first field containing a first and a second field containing or referring to a binary object, where the binary object contains probe intensity values; and a second table comprising a first field containing the first identifier, where the first table is related to second table by the first identifier. The second table may store tiling design information.

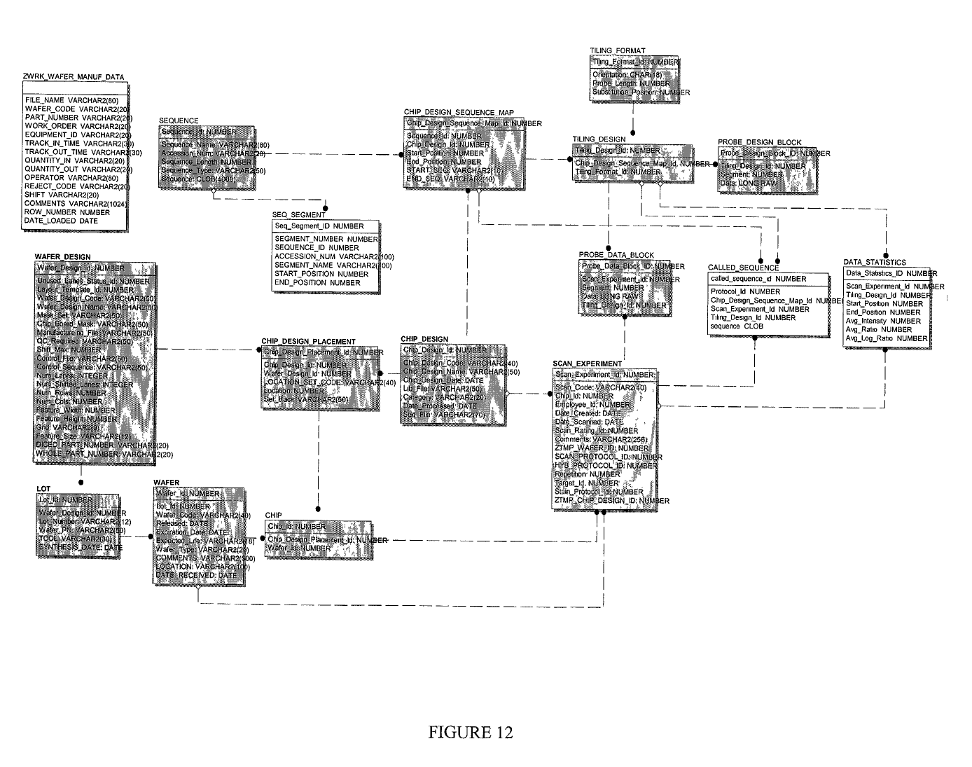

FIG. 12 shows an Entity Relationship Diagram (ERD) of an exemplary relational model for managing probe intensity values and probe design information. An ERD includes entities, relationships, and attributes. A detailed discussion of ERDs is found in, for example, “ERwin version 3.0 Methods Guide” available from Logic Works, Inc. of Princeton, N.J., the contents of which are herein incorporated by reference in its entirety for all purposes. Those of skill in the art will appreciate that automated tools such as Developer 2000 available from Oracle Corporation (Redwood City, Calif.) could convert the ERD from FIGURE directly into executable code such as SQL code for creating and operating the database.

The PROBE_DESIGN_BLOCK table has three fields: Tiling_Design_ID, Segment, and Data. The Data field is for storing binary objects. The PROBE_DATA_BLOCK table contains Scan_Experiment-ID, Segment, Tiling_Design_ID and Data. The identifier Segment and Tiling_Design_ID may be used in combination to relate the data to a particular segment of the design in the PROBE_DESIGN_BLOCK table. The data field is for storing the binary objects of intensity values.

### Conclusion

The present invention provides methods and computer software products for managing large data sets, such as genotyping and gene expression data. It is to be understood that the above description is intended to be illustrative and not restrictive. Many variations of the invention will be apparent to those of skill in the art upon reviewing the above description. The scope of the invention should, therefore, be determined not with reference to the above description, but should instead be determined with reference to the appended claims, along with the full scope of equivalents to which such claims are entitled.

All cited references, including patent and non-patent literature, are incorporated herein by reference in their entireties for all purposes.

What is claimed is:

1. A method for data storage comprising:
grouping a set of data according to its most common access requirements into a plurality of groups; and
storing the groups in a database as single binary objects, wherein each of the groups is stored as one single binary object.

2. The method of claim 1 wherein the database is a relational database.

3. The method of claim 2 wherein the set of data need not to be frequently accessed in arbitrary ways.

4. The method of claim 3 wherein the grouping comprises encoding the data into the binary objects by calling a component software.

5. The method of claim 3 wherein the component software is a COM object.

6. The method of claim 4 further comprising;
retrieving the binary objects from the relational database;
decoding the binary objects into the set of data; wherein the binary objects are encoded in a data structure format that is compatible on a binary level with the decoding.

7. The method of claim 6 wherein the decoding comprises calling a component software for decoding.

8. The method of claim 7 wherein the component software is a COM object.

7. The method of claim 1 wherein the set of data is probe intensity data.

8. The method of claim 7 wherein the probe intensity data are from gene expression experiments and data from each probe set are grouped into one single binary object.

9. The method of claim 7 wherein the probe intensity data are grouped into a single binary object.

10. The method of claim 9 wherein at least 100 probe intensity values are grouped into a single binary object, wherein said 100 probe intensity values.

11. The method of claim 10 wherein at least 1000 probe intensity values are grouped into a single binary object.

12. The method of claim 1 wherein the set of data are probe design data comprising probe information.

13. A method for managing probe array data, wherein the data comprising a plurality of intensity values for a plurality of probes, comprising:
grouping the intensity values into a plurality of groups according to most common access requirement; and
storing the groups in a database as single binary objects, wherein each of the groups is stored as one single binary object.

14. The method of claim 13 wherein the database is a relational database.

15. The method of claim 14 wherein the grouping comprises encoding the data into the binary objects.

16. The method of claim 15 wherein each of the groups comprises at least 100 intensity values.

17. The method of claim 16 wherein each of the groups comprises at least 1000 intensity values.

18. The method of claim 17 wherein each of the groups comprises intensity values for a set of probes, wherein the set of probes is for detecting one transcript.

19. The method of claim 18 wherein the encoding comprises calling a component software.

20. The method of claim 18 wherein the component software is a COM object.

21. The method of claim 19 further comprising;
retrieving the binary objects from the relational database;
decoding the binary objects into the set of data; wherein the binary objects are encoded in a data structure format that is compatible on a binary level with the decoding.

22. A method for managing probe design information comprising:
grouping the probe design information into a plurality of groups according to the most common access requirement; and
storing the groups in a database as single binary objects, wherein each of the groups is stored as one single binary object.

23. The method of claim 22 wherein the database is a relational database.

24. The method of claim 23 wherein the grouping comprises encoding the data into the binary objects.

25. The method of claim 24 wherein each of the groups comprises data for probes in a tiling segment.

26. The method of claim 25 wherein the segment is at least 25 bases.

27. The method of claim 26 wherein the segment is at least 250 bases.

28. The method of claim 28 wherein the encoding comprises calling a component software.

29. The method of claim 29 wherein the component software is a COM object.

30. A system for data management comprising:
a processor; and
a memory coupled with the least one processor, the memory storing a plurality of machine instructions that cause the processor to perform logical steps, wherein the logical steps include:
grouping a set of data according to its most common access requirements into a plurality of groups; and
storing the groups in a database as single binary objects, wherein each of the groups is stored as one single binary object.

31. The system of claim 30 wherein the database is a relational database.

32. The system of claim 31 wherein the set of data need not to be frequently accessed in arbitrary ways.

33. The system of claim 32 wherein the grouping comprises encoding the data into the binary objects by calling a component software.

34. The system of claim 33 wherein the component software is a COM object.

35. The system of claim 34 further comprising;
retrieving the binary objects from the relational database;
decoding the binary objects into the set of data; wherein the binary objects are encoded in a data structure format that is compatible on a binary level with the decoding.

36. The system of claim 35 wherein the decoding comprises calling a component software for decoding.

37. The system of claim 37 wherein the component software is a COM object.

38. The system of claim 30 wherein the set of data is probe intensity data.

39. The system of claim 38 wherein the probe intensity data are from gene expression experiments and data from each probe set are grouped into one single binary object.

40. The system of claim 39 wherein the probe intensity data are grouped into a single binary object.

41. The system of claim 40 wherein at least 100 probe intensity values are grouped into a single binary object.

42. The system of claim 41 wherein at least 1000 probe intensity values are grouped into a single binary object.

43. The system of claim 30 wherein the set of data are probe design data comprising probe information.

44. A system for managing probe array data, wherein the data comprising a plurality of intensity values for a plurality of probes, comprising:
a processor; and
a memory coupled with the processor, the memory storing a plurality of machine instructions that cause the processor to perform logical steps, wherein the logical steps include:
grouping the intensity values into a plurality of groups according to the most common access requirement; and
storing the groups in a database as single binary objects, wherein each of the groups is stored as one single binary object.

45. The system of claim 44 wherein the database is a relational database.

46. The system of claim 45 wherein the grouping comprises encoding the data into the binary objects.

47. The system of claim 46 wherein each of the groups comprises at least 100 intensity values.

48. The system of claim 47 wherein each of the groups comprises at least 1000 intensity values.

49. The system of claim 48 wherein each of the groups comprises intensity values for a set of probes, wherein the set of probes is for detecting one transcript.

50. The system of claim 49 wherein the encoding comprises calling a component software.

51. The system of claim 50 wherein the component software is a COM object.

52. The system of claim 51 further comprising;
retrieving the binary objects from the relational database;
decoding the binary objects into the set of data; wherein the binary objects are encoded in a data structure format that is compatible on a binary level with the decoding.

53. A system for managing probe array design data comprising:
a processor; and
a memory coupled with the processor, the memory storing a plurality machine instructions that cause the processor to perform logical steps, wherein the logical steps include:
grouping probe design information into a plurality of groups according to the most common access requirement; and
storing the groups in a database as single binary objects, wherein each of the groups is stored as one single binary object.

54. The system of claim 53 wherein the database is a relational database.

55. The system of claim 54 wherein the grouping comprises encoding the data into the binary objects.

56. The system of claim 55 wherein each of the groups comprises data for probes in a tiling segment.

57. The system of claim 56 wherein the segment is at least 25 bases.

58. The system of claim 57 wherein the segment is at least 250 bases.

59. The system of claim 58 wherein the encoding comprises calling a component software.

60. The system of claim 59 wherein the component software is a COM object.

61. The system of claim 60 further comprising;
retrieving the binary objects from the relational database;
decoding the binary objects into the set of data; wherein the binary objects are encoded in a data structure format that is compatible on a binary level with the decoding.

62. The system of claim 61 wherein the decoding comprises calling a component software for decoding.

63. The system of claim 62 wherein the component software is a COM object.

64. A computer readable medium having stored thereon a data structure comprising:
a first table comprising a first field containing a first and a second field containing or referring to a binary object, wherein the binary object contains probe intensity values; and
a second table comprising a first field containing the first identifier, wherein the first table is related to second table by the first identifier.

65. The computer readable medium of claim 64 wherein the second table stores tiling design.

66. A computer readable medium comprising computer-executable instructions for performing the methods comprising:
grouping a set of data according to its most common access requirements into a plurality of groups; and
storing the groups in a database as single binary objects, wherein each of the groups is stored as one single binary object.

67. The computer readable medium of claim 66 wherein the database is a relational database.

68. The computer readable medium of claim 67 wherein the set of data need not to be frequently accessed in arbitrary ways.

69. The computer readable medium of claim 68 wherein the grouping comprises encoding the data into the binary objects by calling a component software.

70. The computer readable medium of claim 69 wherein the component software is a COM object.

71. The computer readable medium of claim 68 further comprising;
retrieving the binary objects from the relational database;
decoding the binary objects into the set of data; wherein the binary objects are encoded in a data structure format that is compatible on a binary level with the decoding.

72. The computer readable medium of claim 71 wherein the decoding comprises calling a component software for decoding.

73. The computer readable medium of claim 72 wherein the component software is a COM object.

72. The computer readable medium of claim 66 wherein the set of data is probe intensity data.

73. The computer readable medium of claim 72 wherein the probe intensity data are from gene expression experiments and data from each probe set are grouped into one single binary object.

74. The computer readable medium of claim 73 wherein the probe intensity data are grouped into a single binary object.

75. The computer readable medium of claim 74 wherein at least 100 probe intensity values are grouped into a single binary object, wherein said 100 probe intensity values.

76. The computer readable medium of claim 75 wherein at least 1000 probe intensity values are grouped into a single binary object.

77. The computer readable medium of claim 66 wherein the set of data are probe design data comprising probe information.

78. A computer readable medium for managing data, wherein the data comprising a plurality of intensity values for a plurality of probes, comprising computer-executable instructions for performing the method comprising:
grouping the intensity values into a plurality of groups according to most common access requirement; and
storing the groups in a database as single binary objects, wherein each of the groups is stored as one single binary object.

79. The computer readable medium of claim 78 wherein the database is a relational database.

80. The computer readable medium of claim 79 wherein the grouping comprises encoding the data into the binary objects.

81. The computer readable medium of claim 80 wherein each of the groups comprises at least 100 intensity values.

82. The computer readable medium of claim 81 wherein each of the groups comprises at least 1000 intensity values.

83. The computer readable medium of claim 82 wherein each of the groups comprises intensity values for a set of probes, wherein the set of probes is for detecting one transcript.

84. The computer readable medium of claim 83 wherein the encoding comprises calling a component software.

85. The computer readable medium of claim 84 wherein the component software is a COM object.

86. The computer readable medium of claim 19 wherein the method further comprises;
retrieving the binary objects from the relational database;
decoding the binary objects into the set of data; wherein the binary objects are encoded in a data structure format that is compatible on a binary level with the decoding.

87. A computer readable medium comprising computer-executable instructions for performing the methods comprising:
grouping the probe design information into a plurality of groups according to the most common access requirement; and
storing the groups in a database as single binary objects, wherein each of the groups is stored as one single binary object.

88. The computer readable medium of claim 88 wherein the database is a relational database.

89. The computer readable medium of claim 88 wherein the grouping comprises encoding the data into the binary objects.

90. The computer readable medium of claim 89 wherein each of the groups comprises data for probes in a tiling segment.

91. The computer readable medium of claim 90 wherein the segment is at least 25 bases.

92. The computer readable medium of claim 91 wherein the segment is at least 250 bases.

93. The computer readable medium of claim 92 wherein the encoding comprises calling a component software.

94. The computer readable medium of claim 93 wherein the component software is a COM object.
